(19) United States
(12) Patent Application Publication
(10) Pub. No.: US 2026/0340409 A1
(43) Pub. Date: Oct. 29, 2026

(54) A METHOD FOR REDUCING DIVERSITY OF TWO-SIDED MACHINE LEARNING MODELS

(71) Applicant: Nokia Technologies Oy, Espoo (FI)

(72) Inventors: Rustam PIRMAGOMEDOV, Oulu (FI); Muhammad Majid BUTT, Naperville, IL (US)

(21) Appl. No.: 19/114,284

(22) PCT Filed: Sep. 21, 2023
(86) PCT No.: PCT/FI2023/050538

§ 371 Date: Mar. 21, 2025

(30) Foreign Application Priority Data
Sep. 23, 2022 (FI) 20225831

(51) Int. Cl. G06N 3/096

(52) U.S. Cl. CPC G06N 3/096

(57) ABSTRACT

There is provided an apparatus comprising means for performing the following: transmitting, to a network node, information on at least one two-sided machine learning model supported by the apparatus; or transmitting, to a network node, machine learning profile identity of the apparatus, wherein the machine learning profile identity is associated with at least one two-sided machine learning model supported by the apparatus; wherein the at least one two-sided machine learning model is configured to enable joint inference by the apparatus and the network node; receiving, from the network node, an indication of at least a first selected two-sided machine learning model supported by the apparatus.

### FIELD

Various example embodiments relate to a method for reducing diversity of two-sided machine learning models inferred by a user equipment and a network node.

### BACKGROUND

Machine learning (ML) technology may be used in communication networks for various tasks. A two-sided ML model is a model over which joint inference is performed across a user equipment and a network node.

### SUMMARY

According to some aspects, there is provided the subject-matter of the independent claims. Some example embodiments are defined in the dependent claims. The scope of protection sought for various example embodiments is set out by the independent claims. The example embodiments and features, if any, described in this specification that do not fall under the scope of the independent claims are to be interpreted as examples useful for understanding various example embodiments.

According to a fourth aspect, there is provided a method, comprising, transmitting, by an apparatus to a network node, information on at least one two-sided machine learning model supported by the apparatus; or transmitting, to a network node, machine learning profile identity of the apparatus, wherein the machine learning profile identity is associated with at least one two-sided machine learning model supported by the apparatus; wherein the at least one two-sided machine learning model is configured to enable joint inference by the apparatus and the network node; receiving, by the apparatus from the network node, an indication of at least a first selected two-sided machine learning model supported by the apparatus.

According to an embodiment, the method comprises: starting joint inference of the first selected two-sided machine learning model with the network node.

According to an embodiment, the information on at least one two-sided machine learning model comprises: identities of the at least one two-sided machine learning model supported by the apparatus; and information on function of the at least one two-sided machine learning model supported by the apparatus.

According to an embodiment, the method comprises: receiving, from the network node, an instruction to switch to a second two-sided machine learning model supported by the apparatus, which is also supported by another apparatus served by the network node.

According to an embodiment, the method comprises: switching to the second two-sided machine learning model; and starting joint inference of the second two-sided machine learning model with the network node.

According to an embodiment, the method comprises: determining that the second two-sided machine learning model is not anymore supported by the apparatus; based on the determining, transmitting a negative-acknowledgement to the network node; continuing joint inference of the first selected two-sided machine learning model.

According to an embodiment, the method comprises:—establishing a secondary connection with another network node;—transmitting, to the another network node, information on at least one two-sided machine learning model supported by the apparatus; or transmitting to the another network node, machine learning profile identity of the apparatus, wherein the machine learning profile identity is associated with at least one two-sided machine learning model supported by the apparatus;-starting joint inference of the first selected two-sided machine learning model with the another network node.

According to an embodiment, the method comprises: receiving, from the network node, an instruction to switch to a second two-sided machine learning model supported by the apparatus, which is also supported by the another network node; switching to the second two-sided machine learning model; starting joint inference of the second two-sided machine learning model with the network node and the another network node.

According to an embodiment, the method comprises: while performing joint inference of the first selected two-sided machine learning model with the network node, receiving, from the another network, an indication of a second selected two-sided machine learning model; transmitting, to the another network, a non-acknowledgement and an indication that the apparatus performs joint inference of the first selected two-sided machine learning model with the network node.

According to an embodiment, the method comprises: receiving, from the another network node, an indication of starting joint inference with the first selected two-sided machine learning model or an indication of refusing joint inference with the first selected two-sided machine learning model.

According to a fifth aspect, there is provided a method, comprising:—receiving, by a network node from a user equipment, information on at least one two-sided machine learning model supported by the user equipment; or—receiving, by a network node from a user equipment, machine learning profile identity of the user equipment, wherein the machine learning profile identity is associated with at least one two-sided machine learning model supported by the user equipment; and acquiring, by the network node, based on the machine learning profile identity of the user equipment, information on at least one two-sided machine learning model supported by the user equipment; wherein the at least one two-sided machine learning model is configured to enable joint inference by the apparatus and the user equipment; selecting, by the network node, a first two-sided machine learning model supported by the user equipment; transmitting, by the network node to the user equipment, an indication of selecting at least the first two-sided machine learning model supported by the user equipment.

According to an embodiment, the method comprises: starting joint inference of the first two-sided machine learning model with the user equipment.

According to an embodiment, selecting the first two-sided machine learning model is performed based on other two-sided machine learning model currently jointly inferred by the apparatus and other user equipment(s) or supported by the other user equipment(s).

According to an embodiment, the method comprises:—receiving, from another user equipment served by the apparatus, information on at least one two-sided machine learning model supported by the another user equipment; or—receiving, from another user equipment served by the apparatus, machine learning profile identity of the another user equipment, wherein the machine learning profile identity is associated with at least one two-sided machine learning model supported by the another user equipment; and acquiring, based on the machine learning profile identity of the another user equipment, information on at least one two-sided machine learning model supported by the another user equipment.

According to an embodiment, the method comprises: determining, based on the information on at least one two-sided machine learning model supported by the user equipment and by the another user equipment, a second two-sided machine learning model supported by both user equipments; transmitting, to the user equipment an instruction to switch to the second two-sided machine learning model.

According to an embodiment, the method comprises: transmitting, to the another user equipment, an indication of selecting the second two-sided machine learning model; and starting joint inference of the second two-sided machine learning model with the user equipment and the another user equipment.

According to an embodiment, the method comprises: receiving, from the user equipment, a negative-acknowledgement indicating that the second two-sided machine learning model is not anymore supported by the user equipment; continuing interference of the first two-sided machine learning model with the user equipment; and starting joint inference of the second two-sided machine learning model with the another user equipment.

According to an embodiment, the method comprises: receiving, from another network node serving the user equipment, a request for information on a two-sided machine learning model used for the user equipment; determining that the first two-sided machine learning model is compatible with capabilities of the another network node; transmitting an indication of selecting the first two-sided machine learning model to the another network node.

According to an embodiment, the method comprises: receiving, from another network node serving the user equipment, a request for information on a two-sided machine learning model used for the user equipment; determining that the first two-sided machine learning model is not compatible with capabilities of the another network node; based on the determining, selecting a second two-sided machine learning model which is compatible with capabilities of the user equipment and capabilities of the another network node; transmitting, to the user equipment an instruction to switch to the second two-sided machine learning model.

According to an embodiment, the method comprises: transmitting, to the another network node, an indication of selecting the second two-sided machine learning model; and starting inference of the second two-sided machine learning model with the user equipment and the another network node.

According to a sixth aspect, there is provided a method, comprising: establishing a connection with a user equipment, for which the apparatus is configured to serve as a secondary network node; receiving, from a master network node configured to serve the user equipment, information on a two-sided machine learning model which is compatible with capabilities of the user equipment and capabilities of the secondary network node; starting joint inference of the two-sided machine learning model with the user equipment and the master network node.

According to an aspect, there is provided an apparatus comprising means for performing the method of the fourth aspect and any of the embodiments thereof.

According to an aspect, there is provided an apparatus comprising means for performing the method of the fifth aspect and any of the embodiments thereof.

According to an aspect, there is provided an apparatus comprising means for performing the method of the sixth aspect and any of the embodiments thereof.

According to an embodiment, the means (in any of the previous aspects) comprise at least one processor; and at least one memory storing instructions that, when executed by the at least one processor, cause the performance of the apparatus.

According to an aspect, there is provided a non-transitory computer readable medium comprising instructions that, when executed by an apparatus, cause the apparatus to perform at least: the method of the fourth aspect and any of the embodiments thereof.

According to an aspect, there is provided a non-transitory computer readable medium comprising instructions that, when executed by an apparatus, cause the apparatus to perform at least: the method of the fifth aspect and any of the embodiments thereof.

According to an aspect, there is provided a non-transitory computer readable medium comprising instructions that, when executed by an apparatus, cause the apparatus to perform at least: the method of the sixth aspect and any of the embodiments thereof.

According to an aspect, there is provided a computer program comprising instructions, which, when executed by an apparatus, cause the apparatus to perform a method of the fourth aspect and any of the embodiments thereof.

According to an aspect, there is provided a computer program comprising instructions, which, when executed by an apparatus, cause the apparatus to perform a method of the fifth aspect and any of the embodiments thereof.

According to an aspect, there is provided a computer program comprising instructions, which, when executed by an apparatus, cause the apparatus to perform a method of the sixth aspect and any of the embodiments thereof.

### BRIEF DESCRIPTION OF THE DRAWINGS

Some example embodiments will now be described with reference to the accompanying drawings.

FIG. 1 shows, by way of example, a network architecture of communication system;

FIG. 2a shows, by way of example, a network node serving a plurality of user equipments;

FIG. 2b shows, by way of example, a user equipment in multi connectivity mode;

FIG. 3 shows, by way of example, a flowchart of a method;

FIG. 4 shows, by way of example, a flowchart of a method;

FIG. 5 shows, by way of example, signalling between entities;

FIG. 6 shows, by way of example, signalling between entities;

FIG. 7a shows, by way of example, signalling between entities;

FIG. 7b shows, by way of example, signalling between entities;

FIG. 8 shows, by way of example, signalling between entities;

FIG. 9 shows, by way of example, signalling between entities;

FIG. 10 shows, by way of example, signalling between entities;

FIG. 11 shows, by way of example, signalling between entities; and

FIG. 12 shows, by way of example, a block diagram of an apparatus.

### DETAILED DESCRIPTION

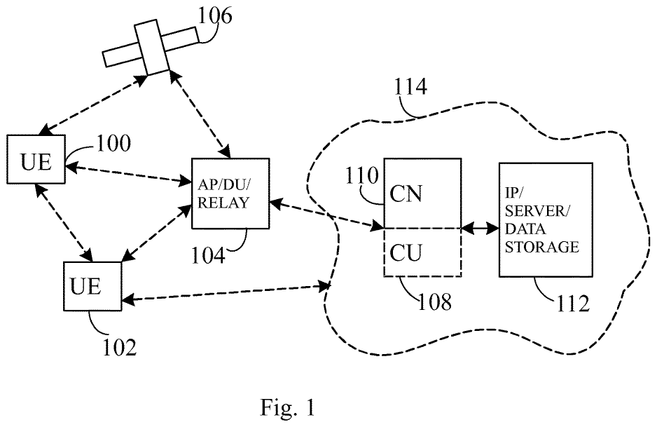

FIG. 1 shows, by way of an example, a network architecture of communication system. In the following, different exemplifying embodiments will be described using, as an example of an access architecture to which the embodiments may be applied, a radio access architecture based on long term evolution advanced (LTE Advanced, LTE-A) or new radio (NR), also known as fifth generation (5G), without restricting the embodiments to such an architecture, however. It is obvious for a person skilled in the art that the embodiments may also be applied to other kinds of communications networks having suitable means by adjusting parameters and procedures appropriately. Some examples of other options for suitable systems are the universal mobile telecommunications system (UMTS) radio access network (UTRAN or E-UTRAN), long term evolution (LTE, the same as E-UTRA), wireless local area network (WLAN or WiFi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

The example of FIG. 1 shows a part of an exemplifying radio access network. FIG. 1 shows user devices or user equipments (UEs) 100 and 102 configured to be in a wireless connection on one or more communication channels in a cell with an access node, such as gNB, i.e. next generation NodeB, or eNB, i.e. evolved NodeB (eNodeB), 104 providing the cell. The physical link from a user device to the network node is called uplink (UL) or reverse link and the physical link from the network node to the user device is called downlink (DL) or forward link. It should be appreciated that network nodes or their functionalities may be implemented by using any node, host, server or access point etc. entity suitable for such a usage. A communications system typically comprises more than one network node in which case the network nodes may also be configured to communicate with one another over links, wired or wireless, designed for the purpose. These links may be used for signalling purposes. The network node is a computing device configured to control the radio resources of the communication system it is coupled to. The network node may also be referred to as a base station (BS), an access point or any other type of interfacing device including a relay station capable of operating in a wireless environment. The network node includes or is coupled to transceivers. From the transceivers of the network node, a connection is provided to an antenna unit that establishes bi-directional radio links to user devices. The antenna unit may comprise a plurality of antennas or antenna elements. The network node is further connected to core network 110 (CN or next generation core NGC). Depending on the system, the counterpart on the CN side can be a serving gateway (S-GW, routing and forwarding user data packets), packet data network gateway (P-GW), for providing connectivity of user devices (UEs) to external packet data networks, or mobile management entity (MME), etc. An example of the network node configured to operate as a relay station is integrated access and backhaul node (IAB). The distributed unit (DU) part of the IAB node performs BS functionalities of the IAB node, while the backhaul connection is carried out by the mobile termination (MT) part of the IAB node. UE functionalities may be carried out by IAB MT, and BS functionalities may be carried out by IAB DU. Network architecture may comprise a parent node, i.e. IAB donor, which may have wired connection with the CN, and wireless connection with the IAB MT.

The user device, or user equipment UE, typically refers to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a user device may also be a nearly exclusive uplink only device, of which an example is a camera or video camera loading images or video clips to a network. A user device may also be a device having capability to operate in Internet of Things (IOT) network which is a scenario in which objects are provided with the ability to transfer data over a network without requiring human-to-human or human-to-computer interaction.

Additionally, although the apparatuses have been depicted as single entities, different units, processors and/or memory units (not all shown in FIG. 1) may be implemented inside these apparatuses, to enable the functioning thereof.

5G enables using multiple input-multiple output (MIMO) technology at both UE and gNB side, many more base stations or nodes than the LTE (a so-called small cell concept), including macro sites operating in co-operation with smaller stations and employing a variety of radio technologies depending on service needs, use cases and/or spectrum available. 5G mobile communications supports a wide range of use cases and related applications including video streaming, augmented reality, different ways of data sharing and various forms of machine type applications (such as (massive) machine-type communications (mMTC), including vehicular safety, different sensors and real-time control. 5G is expected to have multiple radio interfaces, namely below 7 GHz, cmWave and mm Wave, and also being integratable with existing legacy radio access technologies, such as the LTE. Below 7 GHz frequency range may be called as FR1, and above 24 GHz (or more exactly 24-52.6 GHz) as FR2, respectively. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 7 GHz-cmWave, below 7 GHZ-cmWave-mmWave). One of the concepts considered to be used in 5G networks is network slicing in which multiple independent and dedicated virtual sub-networks (network instances) may be created within the same infrastructure to run services that have different requirements on latency, reliability, throughput and mobility.

The communication system is also able to communicate with other networks, such as a public switched telephone network or the Internet 112, or utilize services provided by them. The communication network may also be able to support the usage of cloud services, for example at least part of core network operations may be carried out as a cloud service (this is depicted in FIG. 1 by “cloud” 114). The communication system may also comprise a central control entity, or a like, providing facilities for networks of different operators to cooperate for example in spectrum sharing.

Edge cloud may be brought into radio access network (RAN) by utilizing network function virtualization (NVF) and software defined networking (SDN). Using edge cloud may mean access node operations to be carried out, at least partly, in a server, host or node operationally coupled to a remote radio head or base station comprising radio parts. It is also possible that node operations will be distributed among a plurality of servers, nodes or hosts. Application of cloud RAN architecture enables RAN real time functions being carried out at the RAN side (in a distributed unit, DU 104) and non-real time functions being carried out in a centralized manner (in a centralized unit, CU 108).

5G may also utilize satellite communication to enhance or complement the coverage of 5G service, for example by providing backhauling. Possible use cases are providing service continuity for machine-to-machine (M2M) or Internet of Things (IoT) devices or for passengers on board of vehicles, or ensuring service availability for critical communications, and future railway/maritime/aeronautical communications. Satellite communication may utilise geostationary earth orbit (GEO) satellite systems, but also low earth orbit (LEO) satellite systems, in particular mega-constellations (systems in which hundreds of (nano)satellites are deployed). Each satellite 106 in the constellation may cover several satellite-enabled network entities that create on-ground cells. The on-ground cells may be created through an on-ground relay node 104 or by a gNB located on-ground or in a satellite.

A radio access network (RAN) optimization algorithm may comprise an algorithm for optimizing and/or improving operation, performance and/or one or more functions of a RAN. RAN optimization may comprise, for example, increasing or decreasing a priority of a service. RAN optimization, targeting end-user perception improvement, comprises e.g. capacity and coverage optimization, load sharing, load balancing, random access channel (RACH) optimization and energy saving. These functions may be optimized by self-organizing network (SON) algorithms. SON refers to the ability of the network to work in a self-organized manner. Modern RAN features are expected to have e.g. the following capabilities: self-planning, self-configuration and self-optimization.

A radio access network optimization algorithm may be implemented with, for example, a machine learning technology. The use of ML is applicable in SON solutions as well.

Machine learning (ML) refers to algorithms and statistical models that computer systems use to perform a specific task without using explicit instructions, relying on patterns and inference instead. It is seen as a subset of artificial intelligence (AI). Machine learning algorithms build a mathematical model based on sample data, known as “training data”, in order to make predictions or decisions without being explicitly programmed to perform the task. ML algorithms may be categorized e.g. into supervised, unsupervised, and reinforcement learning. An ML algorithm may be composed of one or several ML components forming a, so called, ML pipeline, where each component may be placed and executed in different RAN network functions and/or in the UE itself.

Two-sided ML model refers to a paired AI/ML model over which joint inference may be performed across the UE and the network. For example, the first part of inference may firstly be performed by UE and the remaining part is then performed by a network node, e.g. gNB, or vice versa.

An example for two-sided ML model is channel state information (CSI) feedback compression with au autoencoder. The encoder may be implemented by the UE, and the decoder may be implemented by the network node, e.g. gNB. The encoder receives the CSI H as an input. The total number of feedback parameters in His Nₜ×Nᵣ×N_{c}, wherein Nₜ is a number of transmit antennas at a gNB, Nᵣ is a number of receiver antennas at a UE, and N_{c} is a number of subcarriers the orthogonal frequency-division multiplexing (OFDM) system operates over. The neural network of the encoder part compresses H into a codeword S of smaller size. In one example S could be 64 bits. The neural network of the decoder part receives S as an input and recovers the H matrix.

Autoencoder may be trained as a whole, or the encoder and decoder parts may be trained separately. In a case of separate training, encoder part may be trained with an unsupervised algorithm, for example. After training of encoder is accomplished, it may use the generated labelled data for supervised training of the decoder.

CSI feedback compression with autoencoders deploying two-sided ML model has been shown to increase speed of the compression.

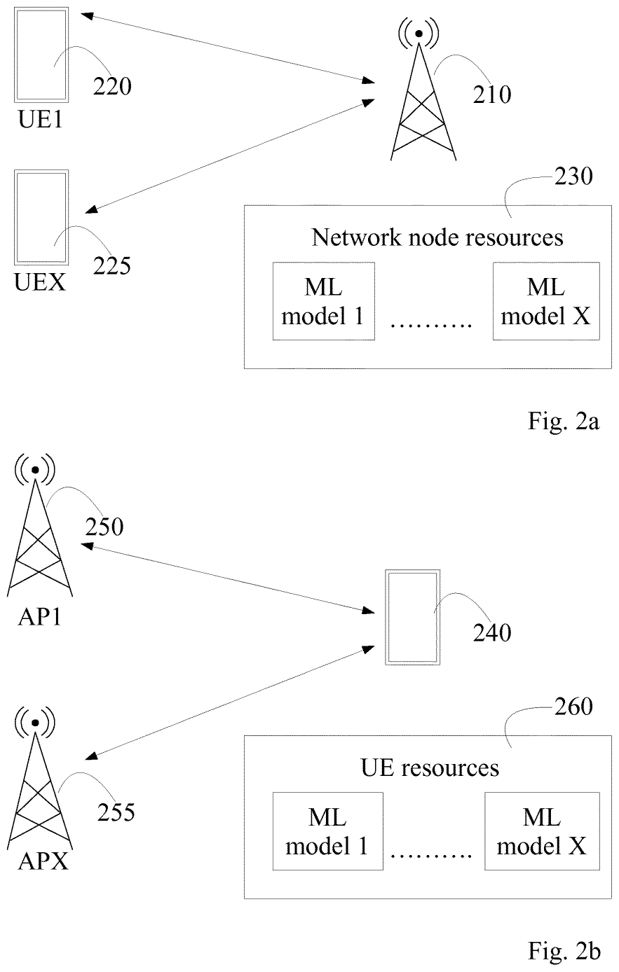

FIG. 2a shows, by way of example, a network node serving a plurality of user equipments, e.g. UE1 220 and UEX 225. The network node 210, e.g. gNB, may perform full or joint inference for various UE functions using ML models hosted at the network node 210 or split between the UEs 220, 225 and the network node 210. With a high number of UEs, and a high number of functions, number of ML models to be run at the network node 210 may be significantly large. Each ML model 1 . . . X consumes resources 230 at the network node 210, including at least random access memory (RAM), and ML accelerator's capacity. Large consumption of the resources by the ML models may cause significant and unpredictable hardware resource demand and potentially their shortage.

FIG. 2b shows, by way of example, a user equipment in multi connectivity mode. The UE 240 may be in multi connectivity mode with a plurality of access points (AP), e.g. AP1 250 and APX 255, or network nodes 250, 255. The UE may perform full or joint inference for various UE functions using ML models hosted at the UE 240 or split between the UE 240 and the access points 250, 255. Running a different ML model for the same function for different connections consumes a lot of resources 260 at the UE 240.

Methods are provided to reduce the diversity of ML models running at a time at the UE and/or at the network node without affecting performance of the functions.

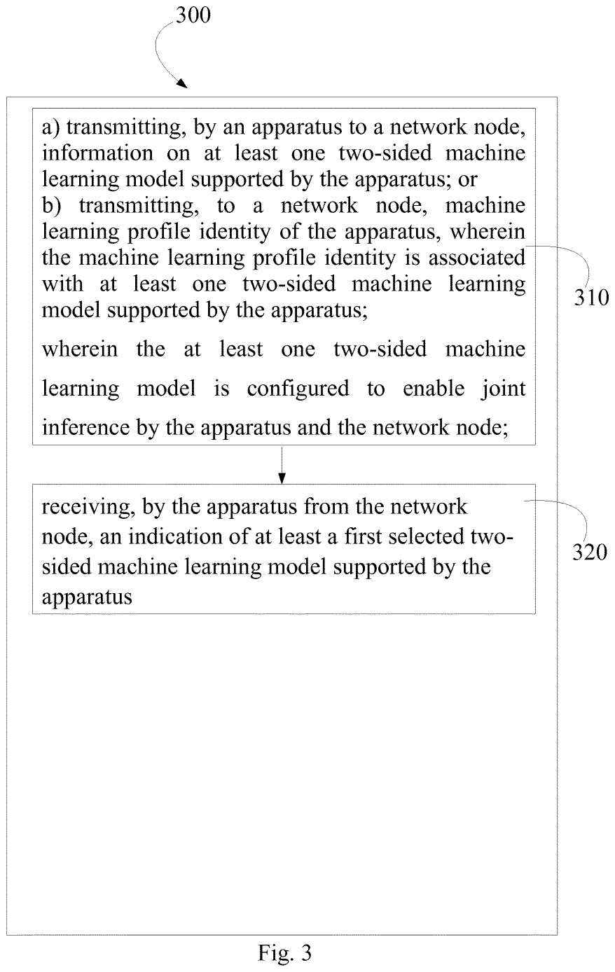

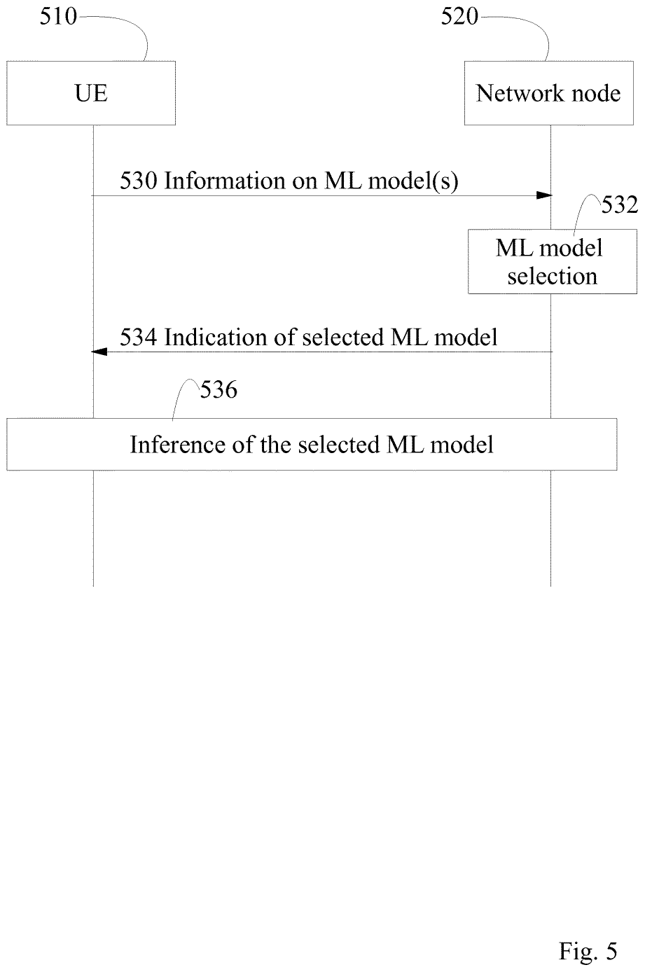

FIG. 3 shows, by way of example, a flowchart of a method 300. The phases of the illustrated method 300 may be performed by a UE, or by a control device configured to control the functioning thereof, when installed therein. The UE may be, for example, the device 510 of FIG. 5, or UE 240 of FIG. 2b, which is configured to perform at least the method 300. The method comprises 310a: transmitting, by an apparatus to a network node, information on at least one two-sided machine learning model supported by the apparatus. Alternatively, the method comprises 310b: transmitting, to a network node, machine learning profile identity (or equally machine learning profile identifier) of the apparatus, wherein the machine learning profile identity is associated with at least one two-sided machine learning model supported by the apparatus. In general, the machine learning profile identity (or identifier) is an identity or identifier which may be used for obtaining information on machine learning capabilities of the apparatus (i.e., on the machine learning profile of the apparatus) including a list of one or more two-sided machine-learning models supported by the apparatus. In other words, the machine learning profile identity (or identifier) serves to identify the machine learning profile of the apparatus (i.e., the machine learning capabilities of the apparatus). The at least one two-sided machine learning model is configured to enable joint inference by the apparatus and the network node. The method 300 comprises receiving 320, by the apparatus from the network node, an indication of at least a first selected two-sided machine learning model supported by the apparatus.

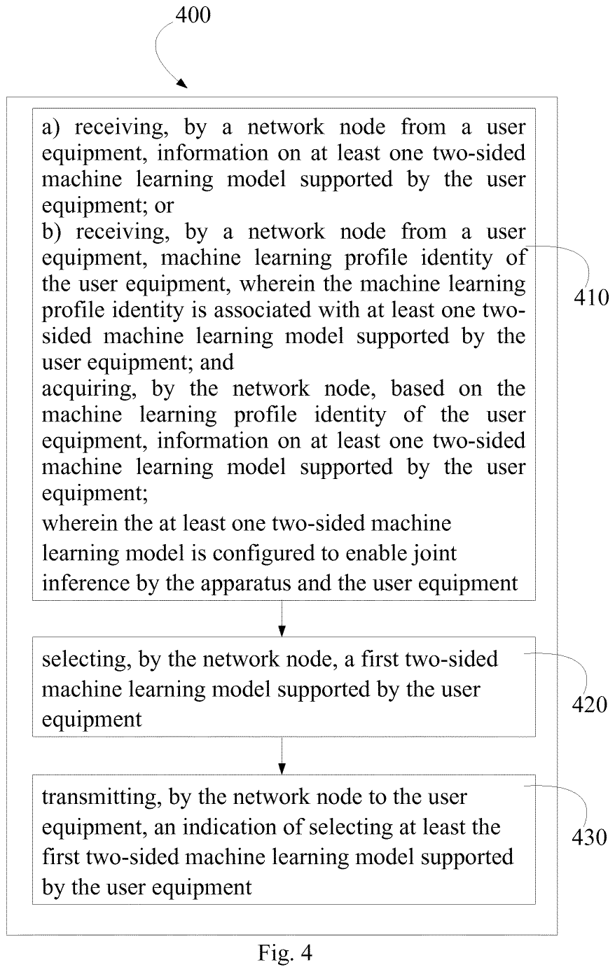

FIG. 4 shows, by way of example, a flowchart of a method 400. The phases of the illustrated method 400 may be performed by a network node, or by a control device configured to control the functioning thereof, when installed therein. The UE may be, for example, the device 520 of FIG. 5, or the network node 210, e.g. gNB, of FIG. 2b, which is configured to perform at least the method 400. The method 400 comprises 410a: receiving, by a network node from a user equipment, information on at least one two-sided machine learning model supported by the user equipment. Alternatively, the method 400 comprises 410b: receiving, by a network node from a user equipment, machine learning profile identity of the user equipment, wherein the machine learning profile identity is associated with at least one two-sided machine learning model supported by the user equipment; and acquiring, by the network node, based on the machine learning profile identity of the user equipment, information on at least one two-sided machine learning model supported by the user equipment. The at least one two-sided machine learning model is configured to enable joint inference by the apparatus and the user equipment. The method comprises selecting 420, by the network node, a first two-sided machine learning model supported by the user equipment. The method comprises transmitting 430, by the network node to the user equipment, an indication of selecting at least the first two-sided machine learning model supported by the user equipment.

The methods as disclosed herein enable reducing diversity of two-sided ML models.

In the following, the methods of FIG. 3 and FIG. 4, and embodiments thereof, will be explained in the context of signalling diagrams.

FIG. 5 shows, by way of example, signalling between entities. The UE 510 transmits 530, to the network node 520, information on at least one two-sided ML model supported by the UE 510. In other words, the UE 510 provides information about its ML capabilities to the network node 520. UE may have one or more ML enabled functions, e.g. best beam prediction in spatial domain and CSI compression. The functions, e.g. each of the functions, may be associated with one or more ML models. ML model selection for the function may be dependent on requirements or input conditions. The requirements may comprise, for example, size of channel feedback after compression by the encoder, computational complexity of the ML model and size of the ML model. The complexity of the ML model may be measured in number of floating point operations (FLOPs). The size of the ML model may be given in Mbytes.

For example, information on the ML models may be included in a list. The list may comprise the functions the different ML models may be used for. For example, the list may comprise function identities (IDs) and IDs of the supported ML models for the functions. For example, the list may comprise pairs [ID of function; ID(s) of the supported ML model(s)].

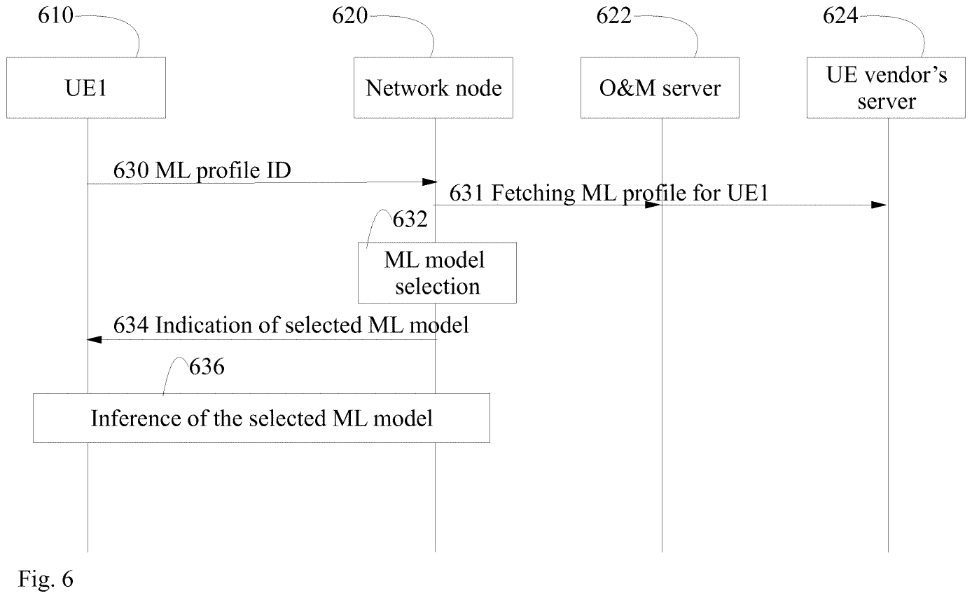

As an alternative to providing the information on the supported ML models, the UE may provide its ML profile identity as explained in the context of FIG. 6.

The network node 520 stores the information on the ML model(s) supported by the UE to a memory. The received information may be paired with the UE ID of the UE 510. The UE ID includes information on UE producer or vendor, UE model, and network identificatory, for example.

The network node 520 may receive the information on ML models from a plurality of UEs attached to the network node 520. The network node 520 may maintain a database of ML models supported by different UEs for different functions.

The network node 520 selects 532 a ML model to be used for inference with the UE 510. The selected ML model may be the first two-sided ML model. The selection may be based on other UE specific models currently inferring at the network node 520. For example, the network node 520 may select the ML model that is currently used with some other UE(s) for the same function. This enables reducing diversity of two-sided ML models simultaneously inferred for UEs. Selecting to use such ML model for the UE 510 which is already in use or supported by other UEs served by the network node 520 enables reducing diversity of the ML models running at the network node simultaneously.

The network node 520 transmits 534, to the UE 510, an indication of at least the selected ML model, or of at least the first two-sided ML model supported by the UE 510.

The UE 510 receives 534 the indication of the selected ML model. The UE 510 starts inference 536 of the first two-sided ML model with the network node 520.

FIG. 6 shows, by way of example, signalling between entities. The UE1 610 transmits 630, to the network node 620, ML profile ID of the UE 610. The ML profile ID is associated with at least one two-sided ML model supported by the UE1 610. ML profiled ID may, for example, be in a form of an UE identifier, e.g. international mobile equipment identity (IMEI). As another example, the ML profile ID may be a dedicated ID for the purpose of indicating ML models supported by the UE.

After receiving 630 the ML profile ID of the UE1 610, the network node 620 is enabled to fetch or acquire the information on at least one two-sided ML model supported by the UE1 610. The network node 620 may acquire 631, based on the ML profile ID, the information on the ML models supported by the UE1 610. The information may be included in a ML profile of the UE1.

The network node 620 may acquire the ML profile from a server, e.g. operations, administration and maintenance (O&M) server 622. The O&M server 622 may receive a request from the network node 620 for a ML profile corresponding to the ML profile ID of the UE1 610. The O&M server 622 may obtain the requested information about ML capabilities of the UE1 from a vendor's server 622.

The network node 620 receives the information on the ML models supported by the UE1 from a server, e.g. from the O&M server 622.

The network node 620 stores the information on the ML model(s) supported by the UE1 610 to a memory.

The network node 620 selects 632 the ML model to be used for inference with the UE1 610. The selected ML model may be the first two-sided ML model. The selection may be based on other UE specific models currently inferring at the network node 620. For example, the network node 620 may select the ML model that is currently used with some other UE(s) for the same function. This enables reducing diversity of two-sided ML models simultaneously inferred for UEs. Selecting to use such ML model for the UE1 610 which is already in use or supported by other UEs served by the network node 620 enables reducing diversity of the ML models running at the network node simultaneously.

The network node 620 transmits 634, to the UE1 610, an indication of at least the selected ML model, or of at least the first two-sided ML model supported by the UE 610.

The UE1 610 receives 634 the indication of the selected ML model. The UE1 610 starts inference 636 of the first two-sided ML model with the network node 620.

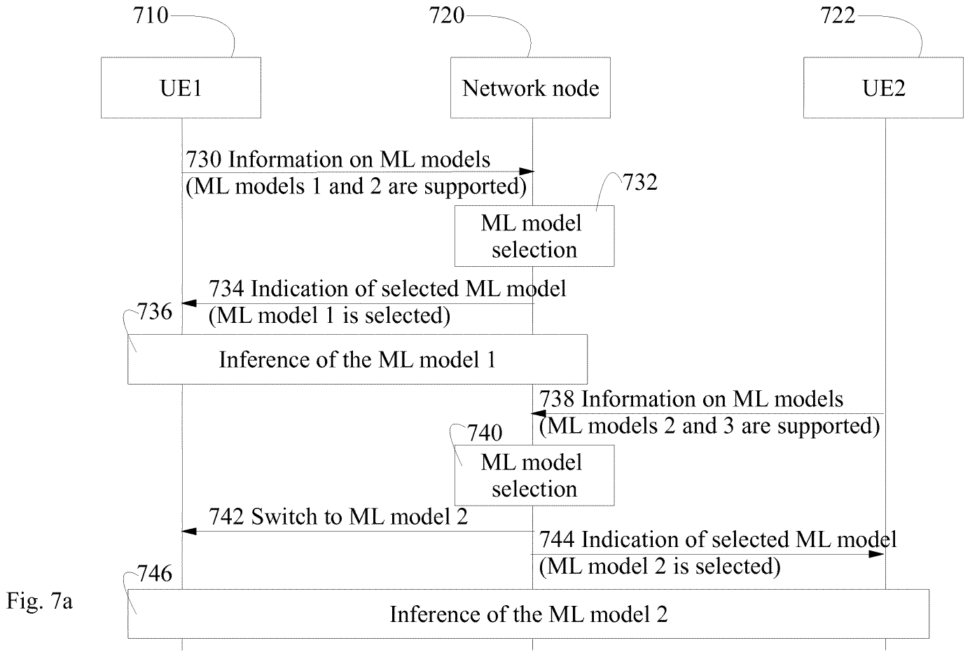

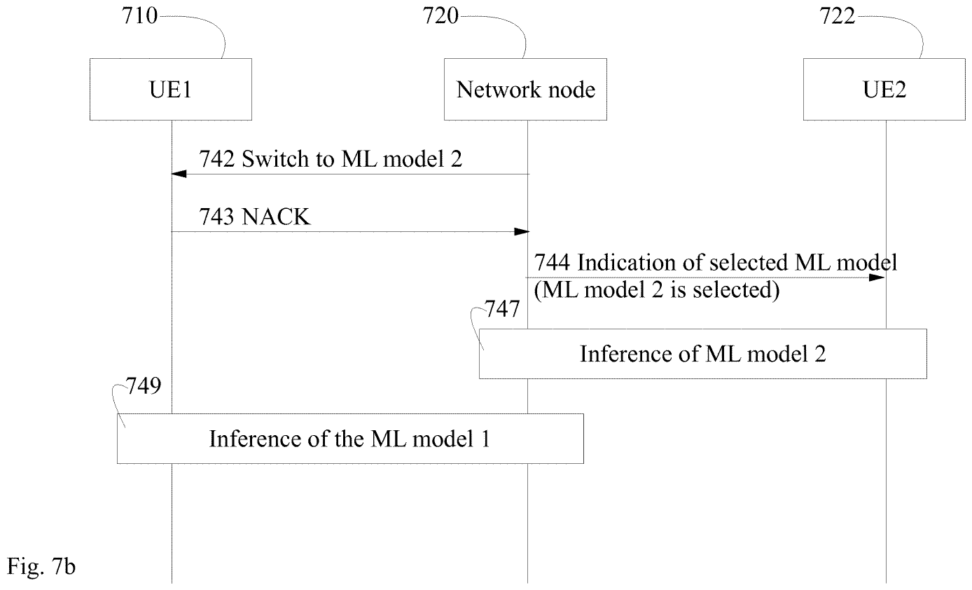

FIG. 7a shows, by way of example, signalling between entities. In the example of FIG. 7a, a plurality of UEs have attached to the network node 720. For example, UE1 710 and UE2 722 have joined the same network node 720. In the example of FIG. 7a, the UE1 and UE2 are assumed to support at least one ML model, which is supported by both UE1 and UE2. This kind of ML model, which is supported by both UE1 and UE2 may be referred to as a common ML model.

The network node 720 receives 730 information on ML models supported by the UE1 710. For example, ML models 1 and 2 are supported by the UE1 710.

The network node 720 stores the received information and performs ML model selection 732. ML model 1 is selected in the example of FIG. 7a.

The network node 720 transmits 734 an indication of the selected ML model to the UE1 710.

The UE1 710 and the network node 720 start inference 736 of the ML model 1.

The network node 720 receives 738 information on ML models supported by another user equipment, the UE2 722. For example, ML models 2 and 3 are supported by the UE2 722.

Alternatively, the network node 720 may receive the ML profile ID of UE2 722, based on which the network node 720 may fetch or acquire the information on supported ML models from a server, as explained in the context of FIG. 6.

The network node 720 performs ML model selection based on information on ML models supported by the UE1 710 and ML models supported by the UE2 722. In the example of FIG. 7a, the UE1 710 and the network node 720 run the two-sided ML model 1 (the first two-sided ML model). However, the UE2 722 does not support the ML model 1.

The network node 720 determines based on the information on the two-sided ML models supported by the UE1 710 and by the UE2 722 a second two-sided ML model supported by the both user equipments, that is, by the UE1 and the UE2. The network node 720 determines a common ML model that may be inferred for the both UEs. In the example of FIG. 7a, the common model is ML model 2 (the second two-sided ML model).

The network node 720 transmits 742 to the UE1 710 an instruction to switch to the ML model 2. The UE1 710 receives 742 the instruction to switch to another ML model supported by the UE1, which ML model is also supported by another UE served by the network node 720. The UE1 710 switches to the ML model 2 (the second two-sided ML model).

The network node 720 transmits 744 to the UE2 722 an indication of the selected ML model, that is, ML model 2.

The network node 720 starts 746 inference of the ML model 2 with the UE1 710 and the UE2 722. Selecting a common ML model for the both UEs, or for a plurality of UEs, the network node 720 reduces resource utilization for ML model inference. Harmonization of the ML models inferred for different UEs enables the network node 720 to save resources.

It is assumed that the network node 720 maintains an up-to-date information on the ML models supported by the UEs attached to it. The UEs may inform the network node about any changes in the information on the ML models supported by the UEs. An example, wherein the network node 720 has an outdated list of ML models for a UE, is shown in FIG. 7b.

FIG. 7b shows, by way of example, signalling between entities. Signalling of FIG. 7b continues from the signalling of FIG. 7a. In the example of FIG. 7b, the UE1 receives 742 the instruction to switch to ML model 2, but determines that the ML model 2 is not anymore supported by the UE1 710. Based on determining that the ML model 2 is not supported by the UE1 710, the UE1 transmits a non-acknowledgement NACK to the network node 720.

The UE1 710 continues 749 inference of the first selected two-sided ML model with the network node 720.

The network node 720 receives 743 the NACK from the UE1 710. The NACK indicates to the network node 720 that the ML model 2 is not anymore supported by the UE1 710. The network node 720 may update the database accordingly.

The network node 720 may decide to run different ML models for UE1 and UE2. The network node 720 may continue inference of the ML model 1 with the UE1 749, and start 747 inference of the ML model 2 with the UE2 722, as indicated 744. For this, the network 720 may ensure that it has enough resources for running different ML models for different UEs. As an alternative to running different ML models for different UEs, the network node 720 may decide to switch one or more UEs to a non-ML algorithm.

UE may support more than one simultaneous connection with network. UE in a multi-connectivity mode is shown in the example of FIG. 2b. For example, radio access network (RAN) may support NR-NR dual connectivity (NR-DC), in which a UE may be connected to a network node, e.g. gNB, which acts as a master node (MN) and another network node, e.g. gNB, which acts as a secondary node (SN). The master node may be a first network node and the secondary node may be a second network node.

As another example, NR-DC may be used when a UE is connected to a single network node, which acts both as a MN and as a SN, and which configures both a master cell group (MCG) and a secondary cell group (SCG).

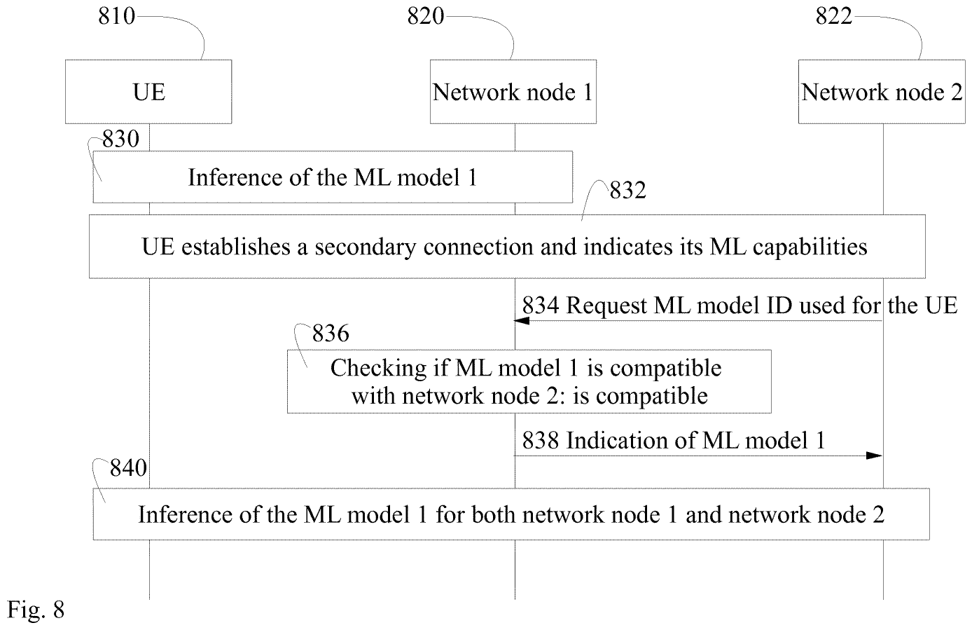

FIG. 8 shows, by way of example, signalling between entities. UE 810 is performing 830 inference of ML model 1 with a network node 1 820, which may be a first network node or a master node (MN).

The UE 810 establishes 832 a secondary connection with a network node 2 822, which may be a second network node or a secondary node (SN) or another network node. The UE 810 transmits information on at least one two-sided ML model supported by the UE 810 to the network node 2 822. The network node 2 822 may maintain a list of ML models supported by the UEs connected to it.

The network node 2 822 requests 834 from the network node 1 information on the ML model used for the UE 810. For example, the network node 2 822 may request for an ML model ID used for the UE 810, e.g. currently used for the UE 810.

The UE may indicate the currently inferred ML model to the network node 2 822 when indicating its ML capabilities at step 832, if the inference with the network node 1 820 has started before the establishment of the secondary connection with the network node 2 822.

The network node 1 820 maintains a list of ML models supported by the UEs connected to it, and a list of ML models supported by neighbouring network nodes that may serve UE in DC mode.

The network node 1 820 checks whether the ML model 1 currently inferred with the UE 810 is compatible with the network node 2 822. The network node 1 820 may determine or check 836 that the ML model 1 is compatible with network node 2 822. The network node 1 820 indicates 838 the ML model 1 to the network node 2 822.

The UE 810 starts 840 inference of the ML model 1 for both network node 1 and network node 2.

Thus, the network node 1 820 ensures that UE does not need to run different ML models for the same function for connections with different network nodes and thereby enables saving UE resources.

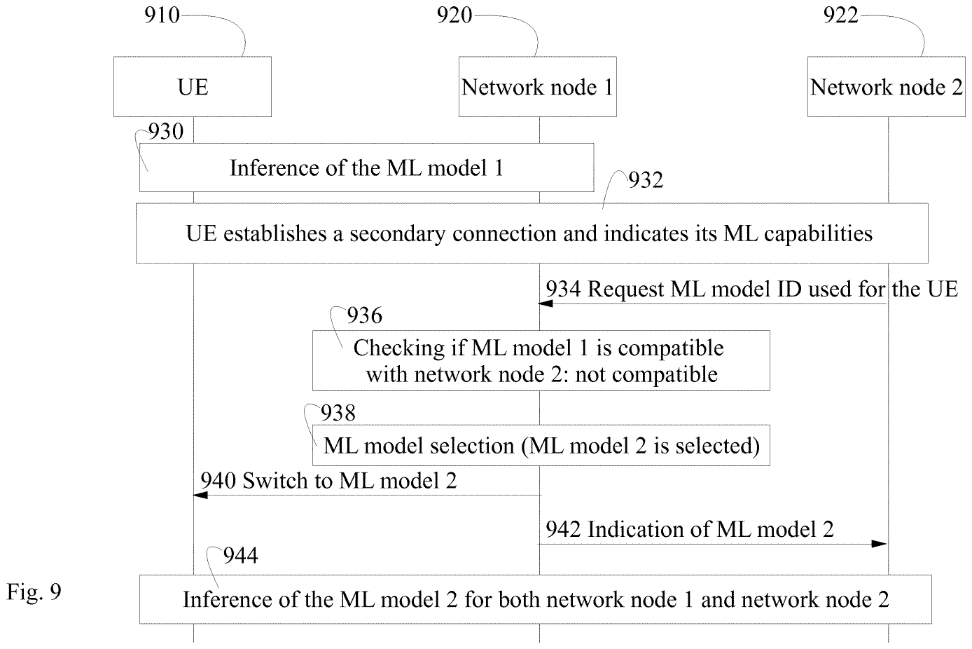

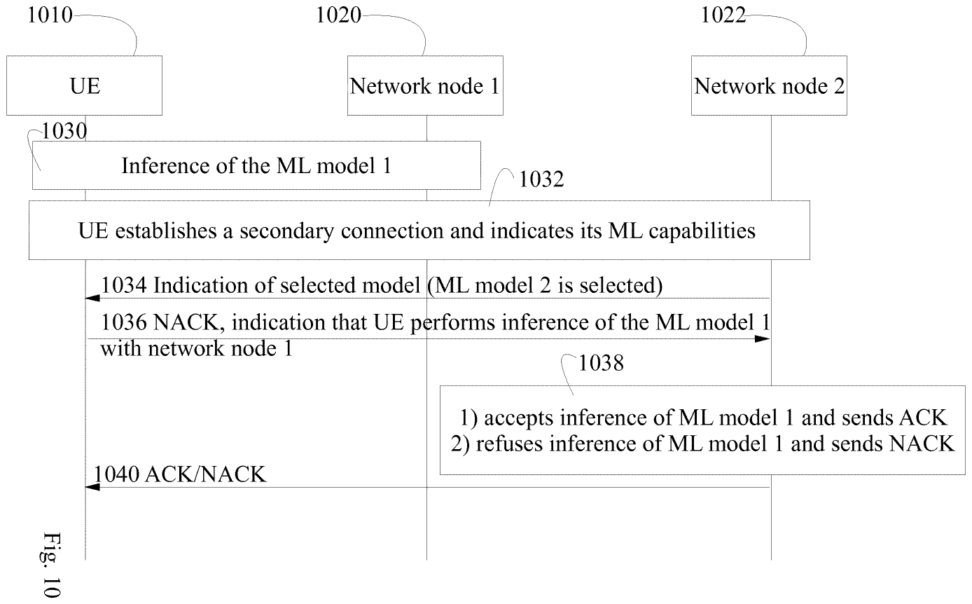

FIG. 9 shows, by way of example, signalling between entities. UE 910 is performing 930 inference of ML model 1 with a network node 1 920, which may be a first network node or a master node (MN).

The UE 910 establishes 932 a secondary connection with a network node 2 922, which may be a second network node or a secondary node (SN). The UE 910 transmits information on at least one two-sided ML model supported by the UE 910 to the network node 2 922. The network node 2 922 may maintain a list of ML models supported by the UEs connected to it.

The network node 2 922 requests 934 from the network node 1 information on the ML model used for the UE 910. For example, the network node 2 922 may request for an ML model ID used for the UE 910, e.g. currently used for the UE 910.

The UE 910 may indicate the currently inferred ML model to the network node 2 922 when indicating its ML capabilities at step 932, if the inference with the network node 1 920 has started before the establishment of the secondary connection with the network node 2 922.

The network node 1 920 maintains a list of ML models supported by the UEs connected to it, and a list of ML models supported by neighbouring network nodes that may serve UE in DC mode.

The network node 1 920 checks whether the ML model 1 currently inferred with the UE 910 is compatible with the network node 2 922. The network node 1 920 may determine 936 that the first two-sided machine learning model is not compatible with the network node 2 922. The network node 1 920 selects 938 ML model 2, which is compatible with the user equipment and the network node 2 922.

The network node 1 920 transmits 940 to the UE 910 an instruction to switch to the ML model 2. The network node 1 920 transmits to the network node 2 an indication of the ML model 2.

The UE 910 starts inference of the common model, i.e. ML model 2, with the network node 1 and the network node 2.

Thus, the network node 1 920 enables model harmonization for UE in DC mode.

If a network node does not support ML-related coordination, the UE may itself ensure model harmonization in DC mode. FIG. 10 shows, by way of example, signalling between entities. The UE 1010 performs 1030 inference of the ML model 1 with the network node 1 1020. The UE 1010 establishes 1032 a secondary connection with a network node 2 1022. The UE indicates its ML capabilities to the network node 2 1022. The network node 2 1022 may maintain a list of ML models supported by the UEs connected to it.

The UE 1010 receives 1034, from the network node 2 1022, an indication of selected ML model 2. This indication may be received while the UE 1010 performs inference of ML model 1 with the network node 2 1020.

The UE 1010 transmits, to the network node 2, a NACK and an indication that the UE performs inference of another ML model, e.g. ML model 1, with the network node 1. The network node 1 is the MN and the network node 2 is the SN.

The UE 1010 may indicate the currently inferred ML model to the network node 2 1022 when indicating its ML capabilities at step 1032, if the inference with the network node 1 1020 has started before the establishment of the secondary connection with the network node 2 1022.

The network node 2 1022 receives the indication of the ML model currently running at the UE. The network node 2 may accept 1038 inference of the ML model 1 and send 1040 an acknowledgement ACK. The network node 2 may refuse 1038 inference of the ML model 1 and send 1040 NACK. The acceptance or refusal may, for example, depend on ML capabilities of the network node 2, or resources at network node 2, such as available central processing unit (CPU) resources and/or occupancy of hardware accelerators for ML.

Thus, the UE in DC may indicate to the secondary cell group (SCG) the ML model used for the master cell group (MCG). This enables the secondary node to decide whether to run the same ML model already inferred by the UE.

Referring back to the O&M server, it is aware of the network topology and may ensure that neighbouring network nodes have at least one compatible ML model for every ML enabled function. By compatible ML models it is meant that the ML models at the network nodes are compatible if a UE is in DC mode and utilizes the same part of a two-sided ML model with both network nodes. For example, for the CSI compression with autoencoder, a UE in DC may run the same encoder model for both network nodes, while the network nodes may have different models for decoders. The different models provide the same, or similar enough, output for the same input. The procedure for configuring compatible ML models at the neighbouring network nodes may be driven by the O&M server.

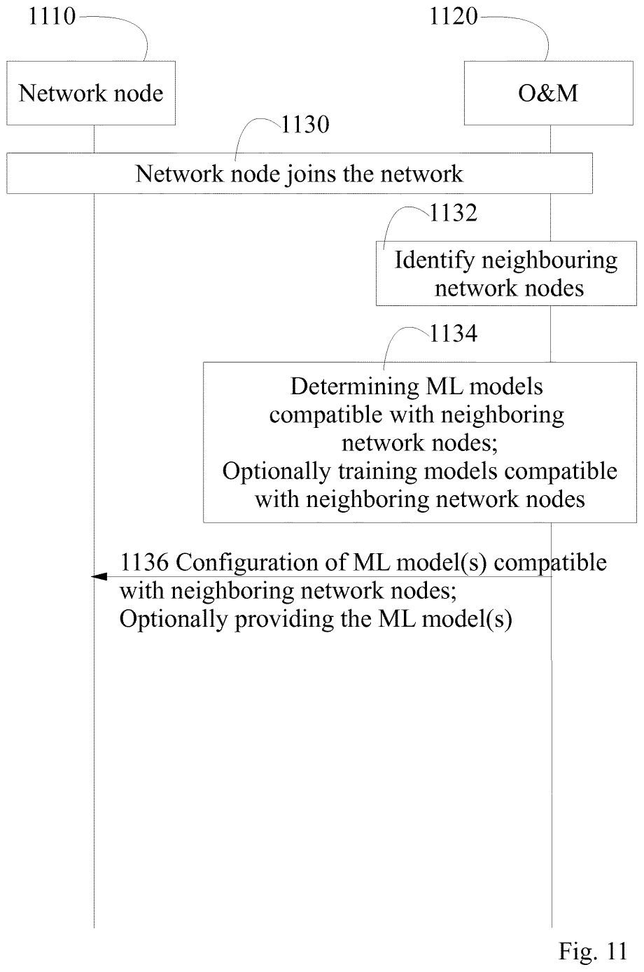

FIG. 11 shows, by way of example, signalling between entities. A network node 1110 joins 1130 the network managed by a management server, e.g. the O&M server 1120. The process of obtaining and configuring the compatible ML models may be triggered when a new network node joins a network.

The O&M server 1120 identifies 1132 neighbouring network node(s) that may be involved in DC for a UE served by the network node 1110.

The O&M server 1120 determines 1134 ML models compatible with the neighbouring network nodes. The server 1120 may maintain a list of compatible ML models. The list may comprise pairs [neighbour ID; IDs of the supported ML models]. Neighbour IDs may comprise new radio cell global identifier (NCGI) of neighbour 1, NCGI of neighbour 2, etc. IDs of the supported ML models may be, for example, ID1, ID2, ID3 for the neighbour 1; and ID3, ID5, ID6 for the neighbour 2.

Optionally, the O&M server 1120 may perform training 1134 of one or more models that will be compatible with neighbouring network nodes.

The O&M server 1120 may configure the network node 1110 with ML model(s) compatible with the neighbouring network nodes. For example, the O&M server 1120 may provide the ML models to the network node 1110. Thus, the O&M server may be configured to provide common ML models, or information on common ML models, for MCG and SCG serving UE in DC.

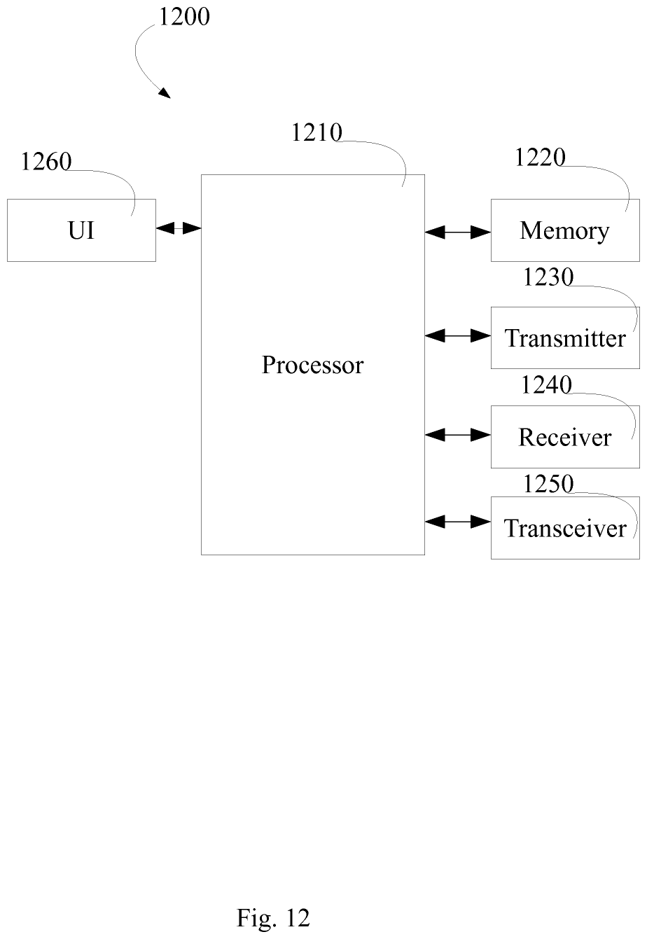

FIG. 12 shows, by way of example, a block diagram of an apparatus capable of performing at least the methods as disclosed herein. Illustrated is device 1200, which may comprise, for example, a mobile communication device such as UE 510 of FIG. 5, or a network node 520 of FIG. 5. Comprised in device 1200 is processor 1210, which may comprise, for example, a single-or multi-core processor wherein a single-core processor comprises one processing core and a multi-core processor comprises more than one processing core. Processor 1210 may comprise, in general, a control device. Processor 1210 may comprise more than one processor. Processor 1210 may be a control device. A processing core may comprise, for example, a Cortex-A8 processing core manufactured by ARM Holdings or a Steamroller processing core designed by Advanced Micro Devices Corporation. Processor 1210 may comprise at least one Qualcomm Snapdragon and/or Intel Atom processor. Processor 1210 may comprise at least one application-specific integrated circuit, ASIC. Processor 1210 may comprise at least one field-programmable gate array, FPGA. Processor 1210 may be means for performing method steps in device 1200. Processor 1210 may be configured, at least in part by computer instructions, to perform actions.

A processor may comprise circuitry, or be constituted as circuitry or circuitries, the circuitry or circuitries being configured to perform phases of methods in accordance with example embodiments described herein. As used in this application, the term “circuitry” may refer to one or more or all of the following: (a) hardware-only circuit implementations, such as implementations in only analog and/or digital circuitry, and (b) combinations of hardware circuits and software, such as, as applicable: (i) a combination of analog and/or digital hardware circuit(s) with software/firmware and (ii) any portions of hardware processor(s) with software (including digital signal processor(s)), software, and memory(ies) that work together to cause an apparatus, such as a user equipment or a network node, to perform various functions) and (c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Device 1200 may comprise memory 1220. Memory 1220 may comprise random-access memory and/or permanent memory. Memory 1220 may comprise at least one RAM chip. Memory 1220 may comprise solid-state, magnetic, optical and/or holographic memory, for example. Memory 1220 may be at least in part accessible to processor 1210. Memory 1220 may be at least in part comprised in processor 1210. Memory 1220 may be means for storing information. Memory 1220 may comprise instructions, such as computer instructions or computer program code, that processor 1210 is configured to execute. When instructions configured to cause processor 1210 to perform certain actions are stored in memory 1220, and device 1200 overall is configured to run under the direction of processor 1210 using instructions from memory 1220, processor 1210 and/or its at least one processing core may be considered to be configured to perform said certain actions. Memory 1220 may be at least in part external to device 1200 but accessible to device 1200.

Device 1200 may comprise a transmitter 1230. Device 1200 may comprise a receiver 1240. Transmitter 1230 and receiver 1240 may be configured to transmit and receive, respectively, information in accordance with at least one cellular or non-cellular standard. Transmitter 1230 may comprise more than one transmitter. Receiver 1240 may comprise more than one receiver. Transmitter 1230 and/or receiver 1240 may be configured to operate in accordance with global system for mobile communication, GSM, wideband code division multiple access, WCDMA, 5G, long term evolution, LTE, IS- 95, wireless local area network, WLAN, Ethernet and/or worldwide interoperability for microwave access, WiMAX, standards, for example.

Device 1200 may comprise user interface, UI, 1260. UI 1260 may comprise at least one of a display, a keyboard, a touchscreen, a vibrator arranged to signal to a user by causing device 1200 to vibrate, a speaker and a microphone. A user may be able to operate device 1200 via UI 1260, for example to accept incoming telephone calls, to originate telephone calls or video calls, to browse the Internet, to manage digital files stored in memory 1220 or on a cloud accessible via transmitter 1230 and receiver 1240, or via NFC transceiver 1250, and/or to play games.

Processor 1210 may be furnished with a transmitter arranged to output information from processor 1210, via electrical leads internal to device 1200, to other devices comprised in device 1200. Such a transmitter may comprise a serial bus transmitter arranged to, for example, output information via at least one electrical lead to memory 1220 for storage therein. Alternatively to a serial bus, the transmitter may comprise a parallel bus transmitter. Likewise processor 1210 may comprise a receiver arranged to receive information in processor 1210, via electrical leads internal to device 1200, from other devices comprised in device 1200. Such a receiver may comprise a serial bus receiver arranged to, for example, receive information via at least one electrical lead from receiver 1240 for processing in processor 1210. Alternatively to a serial bus, the receiver may comprise a parallel bus receiver.

The term “non-transitory” as used herein, is a limitation of the medium itself (i.e., tangible, not a signal) as opposed to a limitation on data storage persistency (e.g., RAM vs. ROM).

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

1-31. (canceled)

32. An apparatus comprising at least one processor; and at least one memory storing instructions that, when executed by the at least one processor, cause the apparatus to: transmit, to a network node, information on at least one two-sided machine learning model supported by the apparatus; or
transmit, to a network node, machine learning profile identity of the apparatus, wherein the machine learning profile identity is associated with at least one two-sided machine learning model supported by the apparatus;
wherein the at least one two-sided machine learning model is configured to enable joint inference by the apparatus and the network node;
receive, from the network node, an indication of at least a first selected two-sided machine learning model supported by the apparatus.

33. The apparatus of claim 32, wherein the apparatus is further caused to:
start joint inference of the first selected two-sided machine learning model with the network node.

34. The apparatus of claim 32, wherein the information on at least one two-sided machine learning model comprises:
identities of the at least one two-sided machine learning model supported by the apparatus; and
information on function of the at least one two-sided machine learning model supported by the apparatus.

35. The apparatus of claim 32, wherein the apparatus is further caused to:
receive, from the network node, an instruction to switch to a second two-sided machine learning model supported by the apparatus, which is also supported by another apparatus served by the network node;
switch to the second two-sided machine learning model; and
start joint inference of the second two-sided machine learning model with the network node.

36. The apparatus of claim 32, wherein the apparatus is further caused to:
receive, from the network node, an instruction to switch to a second two-sided machine learning model supported by the apparatus, which is also supported by another apparatus served by the network node;
determine that the second two-sided machine learning model is not anymore supported by the apparatus;
based on the determining, transmit a negative-acknowledgement to the network node;
continuing joint inference of the first selected two-sided machine learning model.

37. The apparatus of claim 32, wherein the apparatus is further caused to:
establish a secondary connection with another network node;
transmit, to the another network node, information on at least one two-sided machine learning model supported by the apparatus; or
transmit to the another network node, machine learning profile identity of the apparatus, wherein the machine learning profile identity is associated with at least one two-sided machine learning model supported by the apparatus;
start joint inference of the first selected two-sided machine learning model with the another network node.

38. The apparatus of claim 32, wherein the apparatus is further caused to:
establish a secondary connection with another network node;
transmit, to the another network node, information on at least one two-sided machine learning model supported by the apparatus; or
transmit to the another network node, machine learning profile identity of the apparatus, wherein the machine learning profile identity is associated with at least one two-sided machine learning model supported by the apparatus;
start joint inference of the first selected two-sided machine learning model with the another network node;
receive, from the network node, an instruction to switch to a second two-sided machine learning model supported by the apparatus, which is also supported by the another network node;
switch to the second two-sided machine learning model;
start joint inference of the second two-sided machine learning model with the network node and the another network node.

39. The apparatus of claim 32, wherein the apparatus is further caused to:
establish a secondary connection with another network node;
transmit, to the another network node, information on at least one two-sided machine learning model supported by the apparatus; or
transmit to the another network node, machine learning profile identity of the apparatus, wherein the machine learning profile identity is associated with at least one two-sided machine learning model supported by the apparatus;
start joint inference of the first selected two-sided machine learning model with the another network node;
while performing joint inference of the first selected two-sided machine learning model with the network node,
receive, from the another network, an indication of a second selected two-sided machine learning model;
transmit, to the another network, a non-acknowledgement and an indication that the apparatus performs joint inference of the first selected two-sided machine learning model with the network node.

40. An apparatus, comprising at least one processor; and at least one memory storing instructions that, when executed by the at least one processor, cause the apparatus to:
a) receive, from a user equipment, information on at least one two-sided machine learning model supported by the user equipment; or
b) receive, from a user equipment, machine learning profile identity of the user equipment, wherein the machine learning profile identity is associated with at least one two-sided machine learning model supported by the user equipment; and
acquire, based on the machine learning profile identity of the user equipment, information on at least one two-sided machine learning model supported by the user equipment;
wherein the at least one two-sided machine learning model is configured to enable joint inference by the apparatus and the user equipment;
select a first two-sided machine learning model supported by the user equipment;
transmit, to the user equipment, an indication of selecting at least the first two-sided machine learning model supported by the user equipment.

41. The apparatus of claim 40, wherein the the apparatus is further caused to:
start joint inference of the first two-sided machine learning model with the user equipment.

42. The apparatus of claim 40,
wherein selecting the first two-sided machine learning model is performed based on other two-sided machine learning model currently jointly inferred by the apparatus and other user equipment(s) or supported by the other user equipment(s).

43. The apparatus of claims 40, wherein the apparatus is further caused to:
a) receive, from another user equipment served by the apparatus, information on at least one two-sided machine learning model supported by the another user equipment; or
b) receive, from another user equipment served by the apparatus, machine learning profile identity of the another user equipment, wherein the machine learning profile identity is associated with at least one two-sided machine learning model supported by the another user equipment; and
acquire, based on the machine learning profile identity of the another user equipment, information on at least one two-sided machine learning model supported by the another user equipment.

44. The apparatus of claim 40, wherein the apparatus is further caused to:
a) receive, from another user equipment served by the apparatus, information on at least one two-sided machine learning model supported by the another user equipment; or
b) receive, from another user equipment served by the apparatus, machine learning profile identity of the another user equipment, wherein the machine learning profile identity is associated with at least one two-sided machine learning model supported by the another user equipment;
acquire, based on the machine learning profile identity of the another user equipment, information on at least one two-sided machine learning model supported by the another user equipment;
determine, based on the information on at least one two-sided machine learning model supported by the user equipment and by the another user equipment, a second two-sided machine learning model supported by both user equipments, and
transmit, to the user equipment an instruction to switch to the second two-sided machine learning model.

45. The apparatus of claim 40, wherein the apparatus is further caused to:
receive, from another network node serving the user equipment, a request for information on a two-sided machine learning model used for the user equipment;
determine that the first two-sided machine learning model is compatible with capabilities of the another network node;
transmit an indication of selecting the first two-sided machine learning model to the another network node.

46. The apparatus of claim 40, wherein the apparatus is further caused to:
receive, from another network node serving the user equipment, a request for information on a two-sided machine learning model used for the user equipment;
determine that the first two-sided machine learning model is not compatible with capabilities of the another network node;
based on the determining, select a second two-sided machine learning model which is compatible with capabilities of the user equipment and capabilities of the another network node;
transmit, to the user equipment an instruction to switch to the second two-sided machine learning model.

47. The apparatus of claim 40, wherein the apparatus is further caused to:
receive, from another network node serving the user equipment, a request for information on a two-sided machine learning model used for the user equipment;
determine that the first two-sided machine learning model is not compatible with capabilities of the another network node;
based on the determining, select a second two-sided machine learning model which is compatible with capabilities of the user equipment and capabilities of the another network node;
transmit, to the user equipment an instruction to switch to the second two-sided machine learning model;
transmit, to the another network node, an indication of selecting the second two-sided machine learning model; and
start inference of the second two-sided machine learning model with the user equipment and the another network node.

48. A method comprising:
transmitting, by an apparatus to a network node, information on at least one two-sided machine learning model supported by the apparatus; or
transmitting, by an apparatus to a network node, machine learning profile identity of the apparatus, wherein the machine learning profile identity is associated with at least one two-sided machine learning model supported by the apparatus;
wherein the at least one two-sided machine learning model is configured to enable joint inference by the apparatus and the network node;
receiving, by the apparatus from the network node, an indication of at least a first selected two-sided machine learning model supported by the apparatus.
